(19) United States
(12) Patent Application Publication
(10) Pub. No.: US 2024/0054251 A1
(43) Pub. Date: Feb. 15, 2024

(54) REVERSE ENGINEERING SUPPORT APPARATUS

(71) Applicant: Keyence Corporation, Osaka (JP)

(72) Inventors: Kazusa AOKI, Osaka (JP); Jun TABUCHI, Osaka (JP)

(73) Assignee: Keyence Corporation, Osaka (JP)

(21) Appl. No.: 18/222,489

(22) Filed: Jul. 17, 2023

(30) Foreign Application Priority Data
Aug. 9, 2022 (JP) 2022-127396

(51) Int. Cl. G06F 30/10; G01B 11/25

(52) U.S. Cl. CPC G06F 30/10; G01B 11/2518; G06F 2111/04

(57) ABSTRACT

A reverse engineering support apparatus, includes: a data acquisition unit that acquires the mesh data; a reception unit that receives an input of a designated point on the mesh data; an extraction unit that extracts a plane candidate based on the designated point from the mesh data; a plane determination unit that creates a plane constituting a polyhedron based on the plane candidate; and a polyhedron creation unit that creates the polyhedron including the plane created by the plane determination unit. The reception unit can further receive designation of a constraint condition indicating a position and an attitude with respect to another surface or a position and an attitude in a predetermined coordinate system for each surface of the polyhedron, and the plane determination unit creates the plane constituting the polyhedron based on the plane candidate and the constraint condition.

### CROSS-REFERENCE TO RELATED APPLICATIONS

The present application claims foreign priority based on Japanese Patent Application No. 2022-127396, filed Aug. 9, 2022, the contents of which are incorporated herein by reference.

### BACKGROUND OF THE INVENTION

### 1. Field of the Invention

The invention relates to a reverse engineering support apparatus that supports reverse engineering for creating a CAD drawing from data obtained by measuring a three-dimensional shape.

### 2. Description of Related Art

A conventional three-dimensional measurement apparatus is disclosed in JP 2017-227611 A.

This three-dimensional shape measurement device creates mesh data including a large number of polygons from a point cloud obtained by scanning a three-dimensional workpiece.

Further, a geometric element such as a plane, a cylinder, and a rectangular parallelepiped is extracted from the mesh data and converted into CAD data, so that reverse engineering can be easily performed.

However, it has been difficult to create a polyhedron by reflecting a design intention of a user from the mesh data when performing the reverse engineering.

### SUMMARY OF THE INVENTION

An object of the invention is to provide a reverse engineering support apparatus capable of easily creating CAD data of a polyhedron extracted from mesh data by reflecting a design intention of a user.

According to one embodiment of the invention, a reverse engineering support apparatus that converts a polyhedron, created from mesh data obtained by measuring a three-dimensional shape of a workpiece, into CAD data and outputs the CAD data, the reverse engineering support apparatus including:
a data acquisition unit that acquires the mesh data;
a reception unit that receives a designated point on the mesh data and a user input related to a constraint condition for each of surfaces of the polyhedron;
an extraction unit that extracts a plane candidate based on the designated point received by the reception unit from the mesh data;
a plane determination unit that determines a plane constituting the polyhedron based on the plane candidate extracted by the extraction unit and the constraint condition;
a polyhedron creation unit that creates the polyhedron including the plane determined by the plane determination unit; and
a conversion unit that converts the polyhedron created by the polyhedron creation unit into the CAD data.

According to another embodiment of the invention, in the reverse engineering support apparatus having the above-described configuration, the reception unit is capable of receiving, as the user input related to the constraint condition for each of the surfaces of the polyhedron, designation of a position and an attitude with respect to another surface or a position and an attitude in a predetermined coordinate system, and
the plane determination unit determines the plane constituting the polyhedron based on the plane candidate extracted by receiving a user input of the designated point through the reception unit and designation of the constraint condition received by the reception unit.

The plane determination unit determines the plane constituting the polyhedron based on the plane candidate extracted by receiving a user input of the designated point through the reception unit and designation of the constraint condition received by the reception unit.

According to still another embodiment of the invention, in the reverse engineering support apparatus having the above-described configuration, the extraction unit extracts a group of polygons existing within a predetermined angle range with respect to a normal of a polygon including a designated point among polygons continuous with the polygon including the designated point, and extracts a plane approximate to the extracted group of polygons as the plane candidate.

According to still another embodiment of the invention, in the reverse engineering support apparatus having the above-described configuration, the polyhedron creation unit determines whether the constraint condition has been designated by the reception unit for a plurality of planes constituting the polyhedron, and uses the plane candidate extracted by the extraction unit as a surface constituting the polyhedron based on a result of the determination.

According to still another embodiment of the invention, in the reverse engineering support apparatus having the above-described configuration, the polyhedron creation unit determines whether the constraint condition has been designated by the reception unit for a plurality of planes constituting the polyhedron, and uses the plane determined by the plane determination unit based on the constraint condition received by the reception unit as a surface constituting the polyhedron based on the determination result.

According to still another embodiment of the invention, in the reverse engineering support apparatus having the above-described configuration, the reception unit receives designation of a position and an attitude with respect to a first plane forming a reference bottom surface of the polyhedron, as the constraint condition for a second plane forming a reference wall surface adjacent to the first plane, and the plane determination unit creates a plane at the constrained position and attitude with respect to the reference bottom surface as the second plane.

According to still another embodiment of the invention, in the reverse engineering support apparatus having the above-described configuration, the reception unit is capable of receiving designation of a position and an attitude with respect to an apparatus coordinate system as the constraint condition for the first plane.

According to still another embodiment of the invention, in the reverse engineering support apparatus having the above-described configuration, the plane determination unit determines a third plane, a fourth plane, and a fifth plane that are adjacent to the first plane, which is a reference bottom surface, and form side wall surfaces sequentially continuous with the second plane, which is a reference wall surface, and a sixth plane that forms a top surface facing the first plane,
the polyhedron creation unit creates a hexahedron including the first plane, the second plane, the third plane, the fourth plane, the fifth plane, and the sixth plane created by the plane determination unit, and
the reception unit receives designation of a position and an attitude with respect to at least one of the reference bottom surface and the reference wall surface as the constraint condition for each of the third plane, the fourth plane, the fifth plane, and the sixth plane.

According to still another embodiment of the invention, in the reverse engineering support apparatus having the above-described configuration, the plane determination unit creates the sixth plane based on a position and an attitude with respect to the reference bottom surface and the designated point received by the reception unit.

According to still another embodiment of the invention, in the reverse engineering support apparatus having the above-described configuration, the plane determination unit creates the sixth plane using a plane that is parallel to the first plane, which is a reference bottom surface, and intersects the second plane, which is a reference wall surfaces, the third plane, the fourth plane, and the fifth plane.

According to still another embodiment of the invention, in the reverse engineering support apparatus having the above-described configuration, the polyhedron creation unit calculates an intersection point of three adjacent planes among six planes created by the plane determination unit, and creates a hexahedron having the calculated intersection points as a vertex.

According to still another embodiment of the invention, the reverse engineering support apparatus having the above-described configuration further includes an output unit that outputs the CAD data converted by the conversion unit, in which
the polyhedron creation unit is capable of creating a plurality of the polyhedrons,
the conversion unit converts the plurality of polyhedrons into one piece of assembled CAD data, and
the output unit outputs the one piece of assembled CAD data.

According to still another embodiment of the invention, in the reverse engineering support apparatus having the above-described configuration, the reception unit receives selection of one mode out of a first mode in which, as the constraint condition for a predetermined surface of one polyhedron, designation of a position and an attitude with respect to another surface of the one polyhedron is received, and a second mode in which designation of a position and an attitude of a surface of another polyhedron is received as the constraint condition for the predetermined surface of the one polyhedron.

According to still another embodiment of the invention, in the reverse engineering support apparatus having the above-described configuration, the reception unit is capable of further receiving a user input for creating a geometric element from the mesh data,
the conversion unit converts the polyhedron created by the polyhedron creation unit and the geometric element created based on the user input received by the reception unit into one piece of assembled CAD data, and
the output unit outputs the one piece of assembled CAD data.

According to the invention, the plane determination unit determines the plane based on the plane candidate based on the designated point on the mesh data and the constraint condition, and a polyhedron creation unit creates the polyhedron from the plurality of planes including the plane determined by the plane determination unit. As a result, it is possible to easily create the CAD data of the polyhedron extracted from the mesh data at a desired position while reflecting a design intention of a user.

### BRIEF DESCRIPTION OF THE DRAWINGS

FIG. 1 is a system diagram illustrating a three-dimensional measurement apparatus including a reverse engineering support apparatus of an embodiment of the invention;

FIG. 2 is a block diagram illustrating a configuration of the reverse engineering support apparatus of the embodiment of the invention;

FIG. 3 is a flowchart illustrating an operation of the three-dimensional measurement apparatus including the reverse engineering support apparatus of the embodiment of the invention;

FIG. 4 is a flowchart illustrating an operation in a CAD data creation process of the reverse engineering support apparatus of the embodiment of the invention;

FIG. 5 is a flowchart illustrating an operation in a polyhedron creation process of the reverse engineering support apparatus of the embodiment of the invention;

FIG. 6 is a flowchart illustrating an operation in the polyhedron creation process of the reverse engineering support apparatus of the embodiment of the invention;

FIG. 7 is a flowchart illustrating an operation in a geometric constraint process of the reverse engineering support apparatus of the embodiment of the invention;

FIG. 8 is a view illustrating an input screen of a constraint condition of the reverse engineering support apparatus of the embodiment of the invention;

FIG. 9 is a perspective view illustrating a workpiece as a polyhedron creation target of the reverse engineering support apparatus of the embodiment of the invention;

FIG. 10 is a view illustrating a display screen of the reverse engineering support apparatus of the embodiment of the invention on which a reference bottom surface has been received;

FIG. 11 is a view illustrating a display screen of the reverse engineering support apparatus of the embodiment of the invention on which a reference wall surface has been received;

FIG. 12 is a view illustrating a display screen of the reverse engineering support apparatus of the embodiment of the invention on which a side wall surface has been received;

FIG. 13 is a view illustrating a screen of the reverse engineering support apparatus of the embodiment of the invention on which a top surface has been received;

FIG. 14 is a perspective view illustrating an example of a polyhedron created by the reverse engineering support apparatus of the embodiment of the invention;

FIG. 15 is a perspective view illustrating an example in which a plurality of polyhedrons have been created by the reverse engineering support apparatus of the embodiment of the invention;

FIG. 16 is a side view illustrating an example in which the plurality of polyhedrons have been created by the reverse engineering support apparatus of the embodiment of the invention; and

FIG. 17 is a side view illustrating an example in which the plurality of polyhedrons have been created by the reverse engineering support apparatus of the embodiment of the invention.

### DETAILED DESCRIPTION OF PREFERRED EMBODIMENTS

<Three-Dimensional Measurement Apparatus 1>

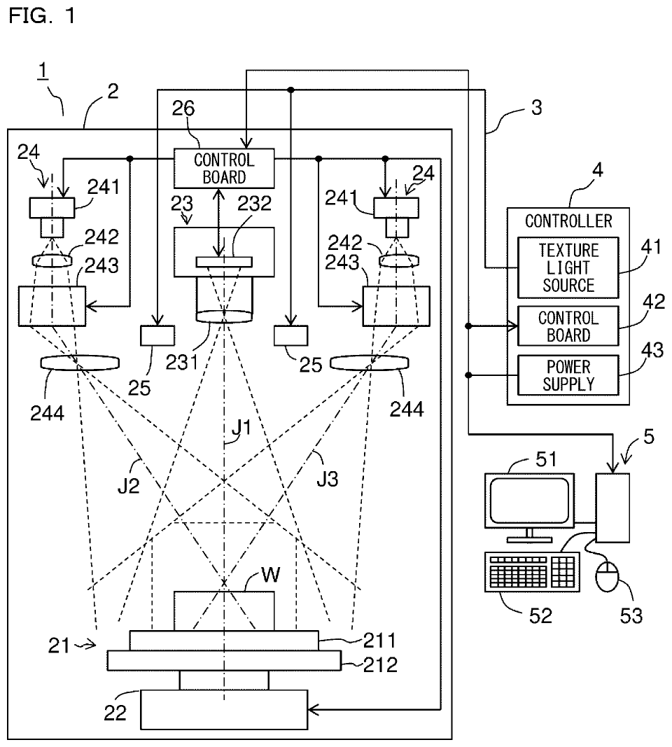

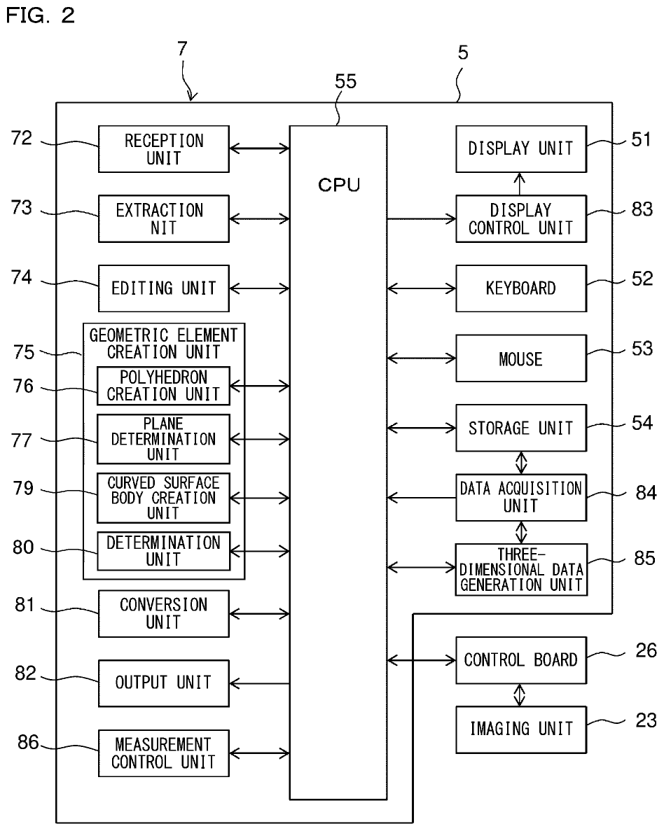

Hereinafter, an embodiment of the invention will be described with reference to the drawings. FIG. 1 is a system diagram illustrating a configuration example of a three-dimensional measurement apparatus 1 of one embodiment. As will be described in detail later, the three-dimensional measurement apparatus 1 is a measurement device that optically measures a three-dimensional shape of a workpiece W, and includes a measurement unit 2, a controller 4, and an information processing terminal 5. Further, the three-dimensional measurement apparatus 1 converts mesh data acquired by measurement into CAD data and outputs the CAD data. As a result, the three-dimensional measurement apparatus 1 can also perform reverse engineering of the workpiece W, and includes a reverse engineering support apparatus 7 (see FIG. 2).

<Measurement Unit 2>

The measurement unit 2 includes a stage 21, a rotation drive unit 22, an imaging unit 23, light projection units 24, texture illumination emission units 25, and a control board 26. The measurement unit 2 is a head unit that irradiates the workpiece W on the stage 21 with detection light of visible light, receives the detection light reflected by the workpiece W, and generates a captured image.

The stage 21 is a work table having a horizontal and flat placement surface on which the workpiece W is to be placed. The stage 21 includes a disk-shaped stage plate 211 and a stage base 212 that supports the stage plate 211.

The rotation drive unit 22 rotates the stage 21 about a rotation axis in the vertical direction in order to adjust an imaging angle with respect to the workpiece W on the stage 21.

The imaging unit 23 is a camera with fixed magnification that captures an image of the workpiece W on the stage 21, and includes a light receiving lens 231 and an imaging element 232. The imaging element 232 receives light from the workpiece W via the light receiving lens 231 and generates a captured image. As the imaging element 232, for example, an image sensor such as a charge coupled device (CCD) or a complementary metal oxide semiconductor (CMOS) is used. The imaging element 232 is, for example, a monochrome image sensor. Note that the magnification of the imaging unit 23 is not necessarily the fixed magnification, and a camera with variable magnification may be used.

The light projection unit 24 is an illumination apparatus that irradiates the workpiece W on the stage 21 with measurement light, and includes a projection light source 241, a collector lens 242, a pattern generation unit 243, and a light projection lens 244. As the projection light source 241, for example, a light emitting diode (LED) or a halogen lamp that generates monochromatic light is used. It is more advantageous to use the monochromatic projection light source 241 as the projection light source 241 than to use a white light source since chromatic aberration correction and the like are easy. Further, it is preferable to use a blue light source, for example, a blue LED as the projection light source 241 since a shorter wavelength is more advantageous for increasing the resolution of three-dimensional shape data. However, a wavelength at which the imaging element 232 can receive light with a favorable S/N is selected.

Note that, if the imaging element 232 is a color image sensor in a case where the monochromatic projection light source 241 is used, for example, a blue light receiving element is used and red and green light receiving elements are not used, so that the number of usable pixels decreases. Therefore, in a case where a pixel size and the number of pixels have been set, it is advantageous to use a monochrome image sensor for the imaging element 232.

The detection light emitted from the projection light source 241 is incident on the pattern generation unit 243 via the collector lens 242. Then, the detection light emitted from the pattern generation unit 243 is emitted to the workpiece W on the stage 21 via the light projection lens 244.

The pattern generation unit 243 is an apparatus configured to generate pattern light for structured illumination, and can switch between uniform detection light and detection light having a two-dimensional pattern. For example, a digital micromirror device (DMD) or a liquid crystal panel is used as the pattern generation unit 243. The DMD is a display element in which a large number of minute mirrors are two-dimensionally arranged, and a bright state and a dark state can be switched for each pixel by controlling an inclination of each of the mirrors.

Examples of a structured illumination method for measuring a three-dimensional shape of the workpiece W using the principle of triangulation include a sinusoidal phase-shifting method, a multi-slit method, a spatial coding method, and the like The sinusoidal phase-shifting method is an illumination method in which a sinusoidal stripe pattern is projected on the workpiece W, and a captured image is acquired each time the stripe pattern is moved at a pitch shorter than the sinusoidal cycle. Three-dimensional shape data is obtained by obtaining a phase value at each pixel from a luminance value of each captured image and converting the value into height information.

The multi-slit method is an illumination method in which a thin stripe pattern is projected on the workpiece W, and of a captured image is acquired each time the stripe pattern is moved at a pitch narrower than an interval between stripes. Three-dimensional shape data is obtained by determining a capturing timing of the maximum luminance of each pixel from a luminance value of each captured image and converting the timing into height information.

The spatial coding method is an illumination method in which a plurality of stripe patterns having different stripe pattern widths and the duty ratio of black/white being 50% are sequentially projected onto the workpiece W to acquire captured images. Three-dimensional shape data is obtained by determining a code value of each pixel from a luminance value of each captured image and converting the value into height information.

In the pattern generation unit 243, the above-described stripe pattern can be generated as the two-dimensional pattern. In the three-dimensional measurement apparatus 1 of the present embodiment, three-dimensional shape data is acquired with high resolution and high accuracy by combining the multi-slit method and the spatial coding method.

Further, two light projection units 24 are arranged in a left-right symmetrical manner across the imaging unit 23. Light projection axes J2 and J3 of the respective light projection unit 24 are inclined with respect to a light reception axis J1 of the imaging unit 23 in order to use the principle of triangulation. In the light projection units 24, the light projection axes J2 and J3 are inclined by offsetting the light projection lenses 244 toward the light reception axis J1 with respect to optical axes of the projection light sources 241, the collector lenses 242, and the pattern generation units 243. Since such a configuration is adopted, the measurement unit 2 can be downsized as compared with a case where the entire light projection unit 24 is inclined.

The texture illumination emission unit 25 emits uniform illumination light of visible light toward the workpiece W on the stage 21 in order to detect a color, a pattern, and the like of the workpiece W as surface texture information. The texture illumination emission units 25 are arranged to surround the light receiving lens 231 of the imaging unit 23 with light projection axes being substantially parallel to the light reception axis J1 of the imaging unit 23. Therefore, a shadow is less likely to be formed on the workpiece W, and a blind spot at the time of capturing is reduced as compared with the illumination from the light projection units 24.

The control board 26 is a circuit board provided with a control circuit that controls the rotation drive unit 22, a drive circuit that drives the projection light sources 241 and the pattern generation units 243 of the light projection units 24, a processing circuit that processes a detection signal from the imaging element 232 of the imaging unit 23, and the like. That is, the control board 26 controls each unit of the measurement unit 2 and processes the detection signal detected by the imaging unit 23.

The controller 4 is a control apparatus of the measurement unit 2, and includes a texture light source 41, a control board 42, and a power supply 43. The texture light source 41 generates illumination light for texture illumination. The control board 42 is provided with a drive circuit and the like for the texture light source 41. The power supply 43 supplies power to each device in the measurement unit 2.

For example, the texture light source 41 sequentially turns on illumination light of each color of red (R), green (G), and blue (B) in order to obtain a color texture image from a captured image. When the imaging element 232 is a monochrome image sensor, it is difficult to acquire color information in a case where texture information is acquired using a white light source as the texture light source 41. Therefore, the texture light source 41 performs illumination by switching among RGB.

The information processing terminal 5 is a terminal apparatus that controls the measurement unit 2 and performs screen display of a captured image, registration of setting information for dimension measurement, generation of three-dimensional shape data, dimension calculation of the workpiece W, and the like.

The information processing terminal 5 is connected to a display unit 51, a keyboard 52, and a mouse 53, and includes a storage unit 54 (see FIG. 2). The display unit 51 is a monitor apparatus that displays a captured image, setting information, and the like on a screen. The keyboard 52 and the mouse 53 are input apparatuses used by a user to perform operation input. The storage unit 54 stores an operation program, setting information, mesh data of a three-dimensional shape, and the like. The information processing terminal 5 is, for example, a personal computer, and is connected to the control board 26 of the measurement unit 2.

<Reverse Engineering Support Apparatus 7>

FIG. 2 is a block diagram illustrating a configuration of the reverse engineering support apparatus 7 included in the three-dimensional measurement apparatus 1. The reverse engineering support apparatus 7 includes the information processing terminal 5 and includes a CPU 55 that controls each unit. The display unit 51, the keyboard 52, the mouse 53, and the storage unit 54 described above are connected to the CPU 55, and the imaging unit 23 is connected via the control board 26.

The CPU 55 is a control circuit or a control element that processes a given signal or data, performs various computations, and outputs computation results. In the present specification, the CPU 55 means an element or a circuit that performs computations, and is not limited to its name. That is, the CPU 55 is not limited to a CPU for a general-purpose PC and processors such as an MPU, a GPU, and a TPU, but is a concept including processors such as an FPGA, an ASIC, and an LSI, a microcomputer, and a chip set such as an SoC.

The storage unit 54 is a circuit that includes storage media such as a semiconductor memory such as a ROM or a RAM, a portable semiconductor memory such as a flash memory, and a hard disk or that is connected to the storage media. The storage unit 54 stores the operation program, the setting information, the mesh data of the three-dimensional shape, and the like.

The display unit 51 is, for example, a monitor apparatus that includes a display panel such as a liquid crystal panel or an organic EL panel and displays the captured image, the mesh image, the setting information, and the like on the screen. The keyboard 52 and the mouse 53 are input apparatuses used by a user to perform operation input. Note that, as an operation input apparatus, a so-called touch panel apparatus used to perform input by coming into contact with an image displayed on the display unit 51 may be adopted. The information processing terminal 5 is, for example, a personal computer, is connected to the control board 26 of the measurement unit 2, and acquires imaging data from the control board 26.

Further, a reception unit 72, an extraction unit 73, an editing unit 74, a geometric element creation unit 75, a conversion unit 81, an output unit 82, a display control unit 83, a data acquisition unit 84, a three-dimensional data generation unit 85, and a measurement control unit 86 are connected to the CPU 55. The geometric element creation unit 75 includes a polyhedron creation unit 76, a plane determination unit 77, a curved surface body creation unit 79, and a determination unit 80.

The reception unit 72, the extraction unit 73, the editing unit 74, the geometric element creation unit 75, the conversion unit 81, the output unit 82, the display control unit 83, the data acquisition unit 84, the three-dimensional data generation unit 85, and the measurement control unit 86 are software stored in the storage unit 54. That is, these units function as the CPU 55 executes the operation program stored in the storage unit 54 of the reverse engineering support apparatus 7.

The measurement control unit 86 controls the stage 21, the imaging unit 23, the light projectors 24, and the texture light source 41 via the control boards 26 and 42 to capture an image of the workpiece W.

The three-dimensional data generation unit 85 measures position information of a plurality of measurement points in a three-dimensional space, and generates point cloud data representing a three-dimensional shape of the workpiece W. Note that the point cloud data is generated based on, for example, a captured image acquired from the imaging unit 23 of the measurement unit 2. Then, three-dimensional mesh data in which surfaces are covered with polygons having a plurality of point clouds, determined by a predetermined algorithm in the point cloud data, as vertexes is generated.

The data acquisition unit 84 acquires three-dimensional shape data of the workpiece W generated by the three-dimensional data generation unit 85 as mesh data (polygon data) and stores the mesh data in the storage unit 54. Further, the data acquisition unit 84 can acquire mesh data which has been taken from the outside and stored in the storage unit 54. Further, the data acquisition unit 71 passes the acquired mesh data to the extraction unit 73 and the display control unit 83.

The reception unit 72 receives a user input such as selection of a geometric element. In the case of creating a polyhedron, the reception unit 72 receives a user input of a designated point (P1 in FIG. 10 or the like) on the mesh data and a constraint condition of each surface of the polyhedron. The reception unit 72 receives an input of a constraint target element and a constraint method as the constraint condition.

The constraint target element is a surface serving as a reference of a constraint with respect to a surface forming a polyhedron, and the reception unit 72 can receive designation of a predetermined surface of the polyhedron, a coordinate surface in a predetermined coordinate system (for example, a coordinate system of the three-dimensional measurement apparatus 1), and the like. As the constraint method, the reception unit 72 can receive designation of a position and an attitude with respect to the constraint target element. Specifically, the reception unit 72 can receive designation of an angle (including parallel and perpendicular) that is an attitude with respect to the constraint target element and designation of a position (an offset amount or the like). Further, the reception unit 72 can also receive a user input of a creation condition of a plane, a cylinder, a sphere, or other geometric elements.

The extraction unit 73 extracts plane candidates based on the designated point (P1 or the like) received by the reception unit 72 from the mesh data, and stores the plane candidates in the storage unit 54.

The editing unit 74 registers each of the extracted plane candidates as a constituent area of a polyhedron. For example, in the case of a hexahedron, the editing unit 74 registers a reference bottom surface, a reference wall surface, three side wall surfaces, and a top surface in the order of reception by the reception unit 72. Further, the editing unit 74 edits and deletes a registered area.

The plane determination unit 77 performs a recalculation process on the plane candidate stored in the extraction unit 73 based on the constraint condition received by the reception unit 72, and determines a plane based on the plane candidate. Further, the plane determination unit 77 stores the plane created based on the plane candidate in the storage unit 54.

The polyhedron creation unit 76 creates a polyhedron by connecting a plurality of the planes stored in the storage unit 54. For example, in the case of a hexahedron, the polyhedron creation unit 76 calculates an intersection point by using three adjacent planes among six planes constituting the hexahedron. Then, the polyhedron creation unit 76 repeats this intersection point calculation process eight times to calculate eight intersection point coordinates, and sets the calculated eight intersection point coordinates as eight vertex coordinates of the hexahedron. That is, the polyhedron creation unit 76 creates a hexahedron element having the calculated eight intersection point coordinates as vertexes.

The curved surface body creation unit 79 creates a geometric element having a curved surface such as a cylinder, a sphere, or a cone based on the creation condition received by the reception unit 72. The polyhedron creation unit 76, the plane determination unit 77, and the curved surface body creation unit 79 constitute the geometric element creation unit 75 that creates a geometric element.

The determination unit 80 determines whether a geometric element such as a creation of a polyhedron is possible based on the contents received by the reception unit 72.

The conversion unit 81 converts a geometric element such as a polyhedron created by the geometric element creation unit 75 into CAD data. The output unit 82 outputs the CAD data converted by the conversion unit 81.

The display control unit 83 creates display data to be displayed on the display unit 51 based on three-dimensional shape data in the storage unit 54. For example, display data for displaying a three-dimensional shape, displayed so as to view an object body in which a large number of measurement points are three-dimensionally arranged from a predetermined viewpoint, on the screen of the display unit 51 is created. A position, a viewpoint, and a display magnification of the three-dimensional shape (the workpiece WO in the screen can be freely designated.

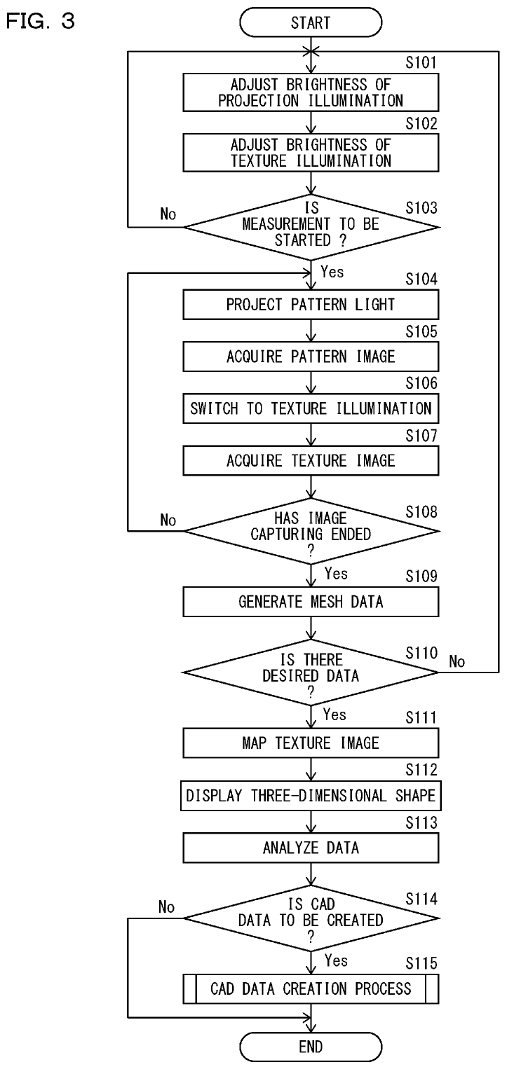

FIG. 3 is a flowchart illustrating an example of an operation of the three-dimensional measurement apparatus 1. When the three-dimensional measurement apparatus 1 is activated, the imaging unit 23 captures an image of the workpiece W placed on the stage 21 under the control of the measurement control unit 86 in Step S101. The display control unit 83 causes the display unit 51 to display the captured image obtained by capturing the workpiece using the imaging unit 23. Then, the reception unit 72 receives adjustment of brightness of a projection illumination, and sends information to control the light projection units 24 to the control board 26 based on the received brightness of the projection illumination. The control board 26 controls the light projection units 24 based on information on the brightness of the projection illumination from the reception unit 72.

In Step S102, the measurement control unit 86 switches to a texture illumination, acquires a captured image, and displays the captured image on the display unit 51 to perform brightness adjustment of the texture illumination. This brightness adjustment is performed by causing the texture illumination emission unit 25 to sequentially or simultaneously emit illumination light of each color of red (R), green (G), and blue (B). The order of Steps S101 and S102 may be changed.

In Step S103, the measurement control unit 86 determines whether the reception unit 72 has received a measurement start instruction from the user. The processing procedure of Steps S101 and S102 are repeated until the reception unit 72 receives the measurement start instruction from the user (No in Step S103). When the reception unit 72 receives the measurement start instruction from the user (Yes in Step S103), the flow proceeds to Step S104.

In Step S104, the light projection units 24 start projecting pattern light. In the next Step S105, the imaging unit 23 acquires a pattern image. This pattern image is a captured image obtained by capturing the workpiece W on the stage 21. The projection of the pattern light and the acquisition of the captured image are performed by synchronizing the pattern generation units 243 and the imaging unit 23.

In Step S106, the measurement control unit 86 switches from the pattern light from the light projection units 24 to the texture illumination from the texture illumination emission unit 25. In Step S107, the imaging unit 23 acquires a texture image. This texture image is obtained by combining a plurality of captured images acquired by sequentially emitting illumination light of each color of red (R), green (G), and blue (B).

In Step S108, the measurement control unit 86 determines whether image capturing has ended. At the time of continuous measurement, the measurement control unit 86 controls the imaging unit 23 and the light projection units 24 via the control board 26, and repeats the processing procedure from Step S104 to Step S107 while sequentially switching the stage 21 to a plurality of imaging angles designated in advance. When the image capturing has ended (Yes in Step S108), the flow proceeds to Step S109.

In Step S109, the three-dimensional data generation unit 85 generates mesh data of a three-dimensional shape based on the pattern image acquired in Step S105, and stores the mesh data in the storage unit 54.

In Step S110, the measurement control unit 86 determines whether three-dimensional shape data has been obtained for a desired measurement site based on a user input received by the reception unit 72. When desired data is not obtained (No in Step S110), the processing procedure from Step S101 to Step S109 is repeated while changing an imaging angle, a capturing condition, and the like. When the desired data is obtained (Yes in Step S110) and an instruction for data analysis from the user is received, the flow proceeds to Step S111.

In Step S111, the measurement control unit 86 maps the texture image on the mesh data stored in Step S109. In Step S112, the display control unit 83 causes the display unit 51 to display the three-dimensional shape data on which the texture image has been mapped as three-dimensional shape of the workpiece W.

In the next Step S113, the three-dimensional data generation unit 85 performs data analysis of the three-dimensional shape data to calculate desired data such as dimensions of the workpiece W. The three-dimensional data generation unit 85 stores the calculated data in the storage unit 54 in association with the mesh data.

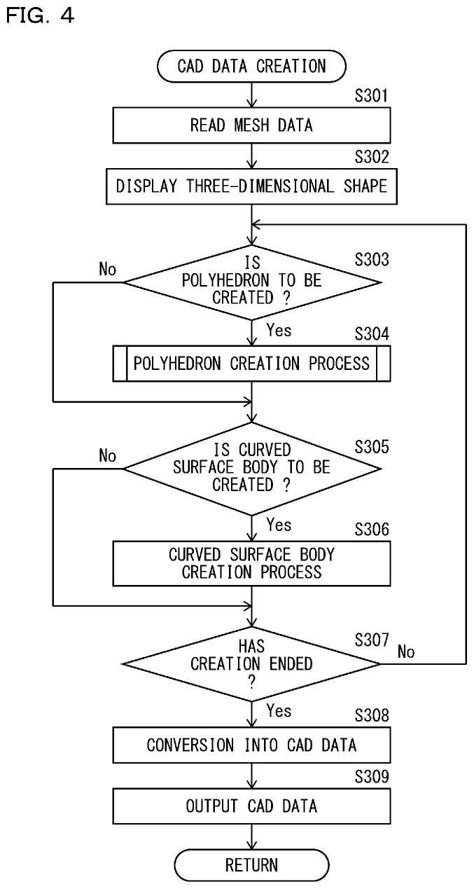

In Step S114, the three-dimensional data generation unit 85 determines whether the reception unit 72 has received an instruction to create CAD data from the mesh data. In a case where there is no instruction to create CAD data (No in Step S114), the three-dimensional data generation unit 85 ends the operation of the three-dimensional measurement apparatus 1. In a case there the instruction to create the CAD data has been received, a CAD data creation process illustrated in FIG. 4 is performed by the geometric element creation unit 75, the conversion unit 81, and the like in Step S115, and then, the operation of the three-dimensional measurement apparatus 1 is ended.

FIG. 4 is a flowchart illustrating an operation in the CAD data creation process. In Step S301, the data acquisition unit 84 reads mesh data from the storage unit 54. In Step S302, the display control unit 83 generates display data for displaying a three-dimensional shape of the workpiece on the display unit 51 based on the mesh data acquired by the data acquisition unit 71. Then, the display control unit 83 displays the three-dimensional shape of the workpiece W on the display unit 51 based on the generated display data.

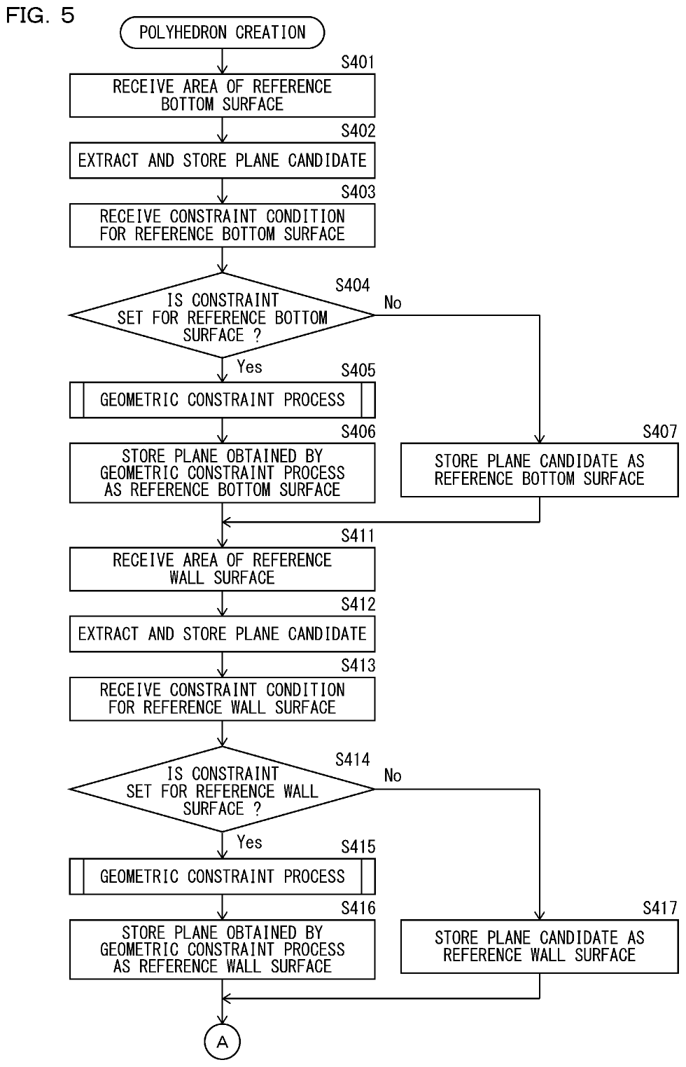

In Step S303, the geometric element creation unit 75 determines whether an instruction to create a polyhedron has been received by the reception unit 72. The flow proceeds to Step S304 to perform a polyhedron creation process illustrated in FIG. 5 in a case where the instruction to create a polyhedron has been received, or proceeds to Step S305 in a case where there is no instruction.

In Step S305, the geometric element creation unit 75 determines whether an instruction to create a curved surface body has been received by the reception unit 72. The flow proceeds to Step S306 to perform a process of creating a cylinder, a sphere, or the like by the curved surface body creation unit 79 in a case where an instruction to create a cylinder or a sphere has been received, or proceeds to Step S307 in a case where there is no instruction.

In Step S307, the geometric element creation unit 75 determines whether creation of a geometric element has ended, and Steps S303 to S306 are repeated in a case where the creation has not ended.

When the creation of a geometric element ends in the determination of Step S307, the flow proceeds to Step S308. In Step S308, shape data of a polyhedron, a curved surface body, or the like created in Step S304 or S306 is converted into CAD data by the conversion unit 81 (see FIG. 2). In Step S309, the CAD data created in Step S308 is output from the output unit 82 (see FIG. 2).

Further, when the geometric element creation unit 75 creates a plurality of geometric elements in Steps S303 to S307, the conversion unit 81 converts the plurality of geometric elements created by the geometric element creation unit 75 into one piece of assembled CAD data. Then, the output unit 82 outputs the one piece of assembled CAD data. The plurality of geometric elements may include a polyhedron. That is, in a case where a plurality of polyhedrons are created by the polyhedron creation unit 76, the conversion unit 81 can convert the plurality of polyhedrons into one piece of assembled CAD data.

At this time, as will be described in detail later, the reception unit 72 may be capable of receiving selection of an operation mode out of a first mode in which, as a constraint condition for a predetermined surface of a polyhedron, a position and an attitude with respect to another surface of the same polyhedron are received and a second mode in which a position and an attitude with respect to a surface of another polyhedron are received.

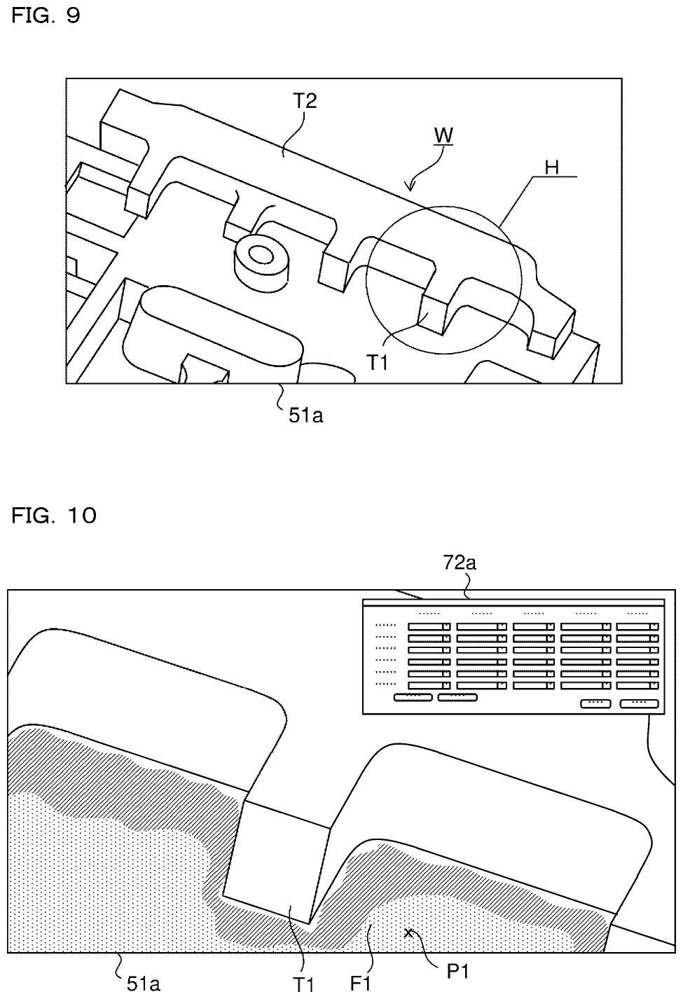

Next, an operation of the polyhedron creation process will be described. Here, the case of creating a rib-shaped element T1, which is a part of the workpiece W illustrated in FIG. 9, as a hexahedron will be described as an example. Other polyhedrons such as an octahedron, a dodecahedron, and an icosahedron can be similarly created. Note that FIGS. 10 to 13 illustrate a display screen 51a obtained by enlarging a part H including the element T1 in FIG. 9, and the dot pattern in the drawings in the drawing represents a contour.

The hexahedron is formed by designating a reference bottom surface, a reference wall surface, three side wall surfaces, and a top surface using the reception unit 72. Each surface of the hexahedron can be constrained by a desired constraint condition for the reference bottom surface or the reference wall surface.

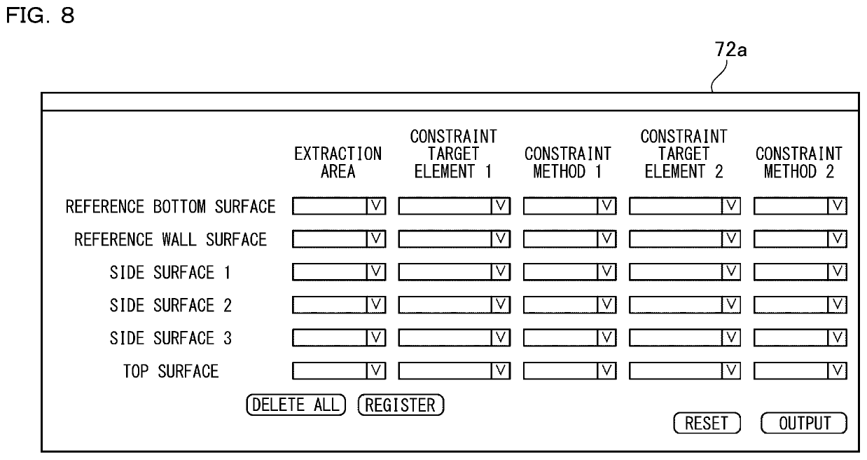

FIG. 8 illustrates an input screen 72a of a constraint condition displayed in the display screen 51a of the display unit 51. The input screen 72a is provided with a field of Extraction area, a field of Constraint target element 1 (a first constraint target element field), a field of Constraint method 1 (a first constraint method field), a field of Constraint target element 2 (a second constraint target element field), and a field of Constraint method 2 (a second constraint method field) for each surface. The field of Extraction area displays a name such as “Region 0” assigned by the reception unit 72 at the time of designating a plane candidate of each surface.

In the field of Constraint target element 1, a first reference surface serving as a reference for constraining each surface is input by the user. In the field of Constraint method 1, a constraint method (parallel, perpendicular, or the like) with respect to the first reference surface designated in the field of Constraint target element 1 is input by the user. In the field of Constraint target element 2, a second reference surface serving as a reference for constraining each surface is input by the user. In the field of Constraint method 2, a constraint method (parallel, perpendicular, or the like) with respect to the second reference surface designated in the field of Constraint target element 2 is input by the user.

As a constraint condition for the reference bottom surface, a coordinate system of the three-dimensional measurement apparatus 1 can be designated. In this case, an upper surface of the stage 21 can be designated as the reference bottom surface by inputting “XY coordinate plane” of the three-dimensional measurement apparatus 1 to the field of Constraint target element 1 and inputting “parallel constraint” to the field of Constraint method 1. Further, a parallel constraint with respect to a predetermined coordinate system can also be designated as a constraint condition for the reference bottom surface. In this case, a plane parallel to the predetermined coordinate system can be set as the reference bottom surface, and thus, it is easy to reflect a design intention of the user on the reference bottom surface.

As a constraint condition for the reference wall surface, designation of a position and an attitude such as a position and an intersection angle with respect to the reference bottom surface can be received. For example, an angle condition such as “perpendicular to reference bottom surface” can be received by inputting “reference bottom surface” to the field of Constraint target element 1 and inputting “perpendicular constraint” to the field of Constraint method 1. Further, as a constraint condition for the reference wall surface, the reception unit 72 can also receive a specific angle value such as “30 degrees with respect to reference bottom surface” as an angle condition.

As a constraint condition for each of the three side wall surfaces (Side surface 1, Side surface 2, and Side surface 3), designation of a position and an attitude such as a position and an intersection angle with respect to at least one of the reference bottom surface and the reference wall surface can be received. For example, a condition such as “perpendicular to reference bottom surface and perpendicular to reference wall surface” can be received by inputting “reference bottom surface”, “perpendicular constraint”, “reference wall surface”, and “perpendicular constraint” to the field of Constraint target element 1, the field of Constraint method 1, the field of Constraint target element 2, and the field of Constraint method 2, respectively, for Side surface 1.

Further, a constraint condition such as “parallel to reference wall surface” can be received by inputting “reference wall surface” and “parallel constraint” to the field of Constraint target element 1 and the field of Constraint method 1, respectively, for Side surface 2. A constraint condition such as “perpendicular to reference bottom surface and perpendicular to reference wall surface” can be received by inputting “reference bottom surface”, “perpendicular constraint”, “reference wall surface”, and “perpendicular constraint” to the field of Constraint target element 1, the field of Constraint method 1, the field of Constraint target element 2, and the field of Constraint method 2, respectively, for Side surface 3.

The case where the constraint condition of each of Side surfaces 1 to 3 is set as “perpendicular” or “parallel” with respect to the reference bottom surface or the reference wall surface has been described, but the embodiment is not limited thereto. Similarly to the angle condition set to the reference wall surface, as the constraint condition of each of Side surfaces 1 to 3, a specific angle value such as “30 degrees with respect to reference bottom surface” can be received as the angle condition.

As a constraint condition for the top surface, designation of a position and an attitude such as a position and an intersection angle with respect to at least one of the reference bottom surface and the reference wall surface can be received. For example, a constraint condition such as “parallel to reference bottom surface” can be received by inputting “reference bottom surface” to the field of Constraint target element 1 and inputting “parallel constraint” to the field of Constraint method 1. Further, a constraint condition such as “perpendicular to reference wall surface” can be received by inputting “reference wall surface” to the field of Constraint target element 1 and inputting “perpendicular constraint” to the field of Constraint method 1.

The input of a constraint condition for the input screen 72a can be performed each time a designated point of each surface is input, before the designated points of the six surfaces are input, or after the designated points of the six surfaces have been input. The constraint condition input to the input screen 72a is stored in the storage unit 54. Hereinafter, a case where a constraint condition is input each time a designated point of each surface is input will be described as an example, but the present embodiment is not limited thereto, and a constraint condition for each surface may be input after each surface of a polyhedron has been designated.

Further, a polyhedron creation mode in which constraint conditions among surfaces have been designated in advance, such as a cuboid creation mode, may be prepared, and a polyhedron in which predetermined constraint conditions have been set may be created by receiving designation of a surface by a user. In this case, the reception unit 72 receives designation of a mode such as “cuboid creation mode” as a user input related to a constraint condition.

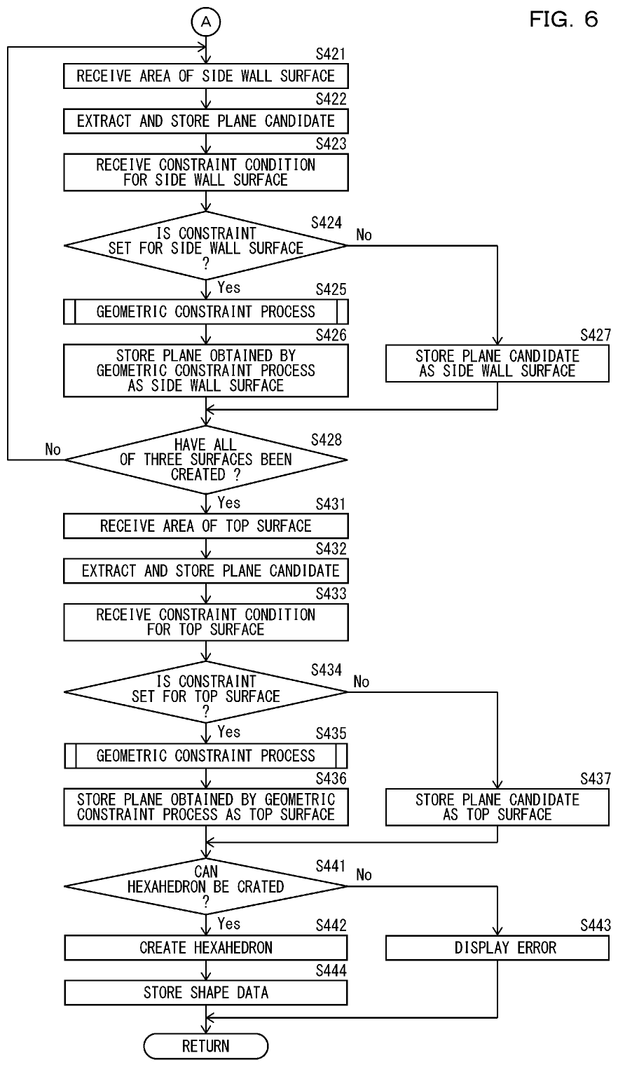

FIGS. 5 and 6 illustrate flowcharts of the polyhedron creation process. In Step S401, a user input for extracting a reference bottom surface of a hexahedron is received by the reception unit 72. Specifically, a three-dimensional image of the workpiece W is displayed on the display screen 51a of the display unit 51 under the control of the display control unit 83 as illustrated in FIG. 10. The reception unit 72 receives a user input of the designated point P1 on a desired surface on the three-dimensional image of the workpiece W displayed on the display screen 51a. As a result, the user input for extracting the reference bottom surface is received.

In Step S402, the extraction unit 73 extracts a plane candidate of the reference bottom surface from the mesh data based on the designated point P1 received in Step S401. Then, the extraction unit 73 stores the extracted plane candidate in the storage unit 54.

Specifically, the extraction unit 73 first extracts, from among polygons continuous with a polygon including the designated point P1, a first polygon group including a plurality of polygons whose normal directions with respect to the polygon including the designated point P1 are within a predetermined angular range. Next, the extraction unit 73 calculates a first plane approximate to the first polygon group. Next, the extraction unit 73 extracts, from among the polygons continuous with the polygon including designated point P1, a second polygon group including a plurality of polygons each of which has an angle with respect to a normal of the first plane being within a predetermined angle range and has a distance from the first plane being within a predetermined range. Then, a second plane approximate to the second polygon group is calculated, and the second plane is stored in storage unit 54 as a plane candidate. The angle range of the normal direction for extracting the polygon group is previously determined to be, for example, 5 degrees or less or 10 degrees or less.

Note that the case where the plane candidate is extracted from the mesh data based on the normal direction has been described here, but a curvature value can also be used without being limited to the normal direction. In a case where a plane candidate is extracted from the mesh data based on the curvature value, the extraction unit 73 extracts a first polygon group including a plurality of polygons continuous with a polygon including the designated point P1 and having a curvature value of zero. Next, the extraction unit 73 calculates a first plane approximate to the first polygon group, and extracts a second polygon group including a plurality of polygons whose distances from the first plane are within a predetermined range. Then, a second plane approximate to the second polygon group is calculated, and the second plane is stored in storage unit 54 as a plane candidate.

Further, the extraction unit 73 can also calculate a plane candidate using a point cloud without being limited to the polygon. Specifically, a first point cloud within a predetermined angle range with respect to a normal of a point nearest to the designated point P1 is extracted from point clouds continuous with a point cloud including the designated point P1. Next, the extraction unit 73 calculates a first plane approximate to the first point cloud. Next, the extraction unit 73 extracts a second point cloud including a plurality of point clouds each of which has an angle with a normal of the first plane being within a predetermined angle range and has a distance from the first plane being within a predetermined range, from among the point clouds continuous with the point cloud including the designated point P1. Then, a second plane approximate to the second point cloud is calculated, and the second plane is stored in storage unit 54 as the plane candidate.

In Step S403, the reception unit 72 receives a constraint condition of the reference bottom surface. The constraint condition of the reference bottom surface is designated by user inputs in the field of Constraint target element 1 and the field of Constraint method 1 of the input screen 72a. When the field of Constraint target element 1 is “XY coordinate plane” and the field of Constraint method 1 is “parallel constraint”, an upper surface of the stage 21 is designated as a first plane F1. At this time, the designation of the designated point P1 is unnecessary, and thus, a polyhedron including a surface having no mesh data can be created.

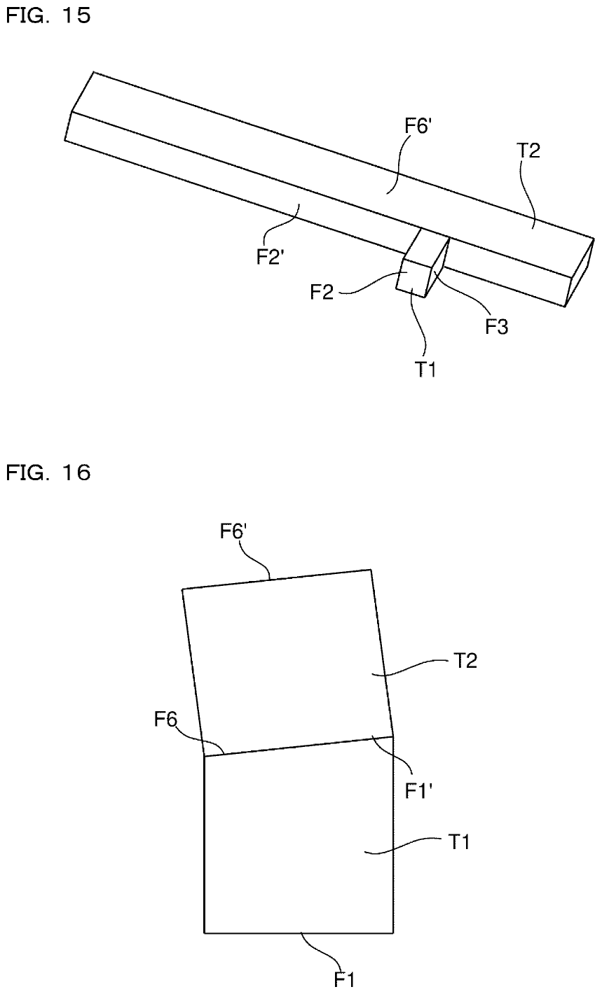

Note that a plurality of polyhedrons can be created by Steps S303 to S307 (see FIG. 4) as described above. At this time, the first mode in which a constraint target element with respect to a predetermined surface is a surface of the same polyhedron and the second mode in which a surface of another polyhedron is used are provided although a specific example will be described later (see FIGS. 15 and 16). As a result, CAD data in which the plurality of polyhedrons are assembled in a desired arrangement can be obtained. Further, a mode in which a position and an attitude with respect to a surface of a geometric element other than the polyhedron are received as a constraint condition of a surface of the polyhedron may be provided.

In Step S404, the polyhedron creation unit 76 determines whether the constraint condition for the reference bottom surface (first plane F1) is set. This determination is made based on the input contents on the input screen 72a. When the polyhedron creation unit 76 determines that the constraint condition is not set, the flow proceeds to Step S407.

In Step S407, the polyhedron creation unit 76 stores the plane candidate extracted by the extraction unit 73 and stored in the storage unit 54 as the reference bottom surface (first plane F1). That is, in a case where the reception unit 72 has not received the constraint condition for the reference bottom surface, the polyhedron creation unit 76 sets the plane candidate extracted by the extraction unit 73 as the reference bottom surface.

In a case where the polyhedron creation unit 76 determines in Step S404 that the constraint condition has been set, the flow proceeds to Step S405. In Step S405, the plane determination unit 77 performs a geometric constraint process to be described later. In Step S406, the polyhedron creation unit 76 stores a plane, created by recalculating a plane candidate by the plane determination unit 77 through the geometric constraint process, in the storage unit 54 as the reference bottom surface.

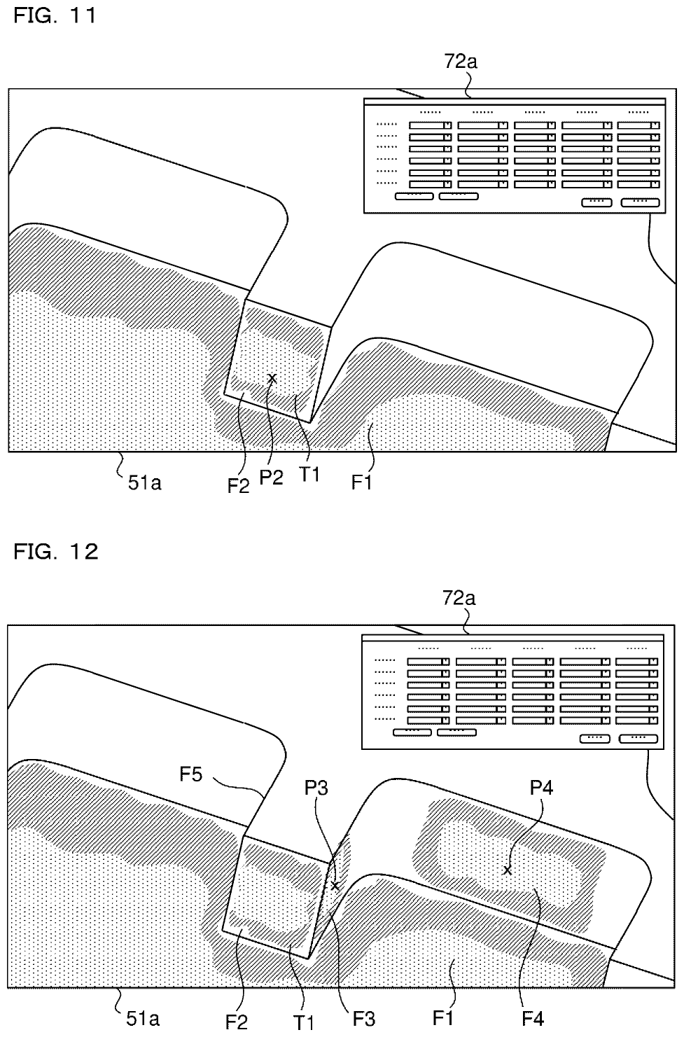

In Step S411, the reception unit 72 receives designation of a reference wall surface adjacent to the reference bottom surface of the hexahedron. Specifically, as illustrated in FIG. 11, a user input of a designated point P2 is received on a desired surface intersecting the first plane F1 on the three-dimensional image of the workpiece W displayed on the display screen 51a of the display unit 51. As a result, the user input for extracting the reference wall surface is received.

In Step S412, similarly to Step S402, the extraction unit 73 extracts a plane candidate of the reference wall surface from the mesh data based on the designated point P2 received in Step S411. Then, the extraction unit 73 stores the extracted plane candidate in the storage unit 54.

In Step S413, the reception unit 72 receives a constraint condition of the reference wall surface. As described above, the reception unit 72 can receive designation of a position and an attitude such as a position and an intersection angle with respect to the first plane F1, which is the reference bottom surface, as the constraint condition for the reference wall surface.

In Step S414, the polyhedron creation unit 76 determines whether the constraint condition for the reference wall surface (second plane F2) is set. When the polyhedron creation unit 76 determines that the constraint condition is not set, the flow proceeds to Step S417.

In Step S417, the polyhedron creation unit 76 stores the plane candidate extracted by the extraction unit 73 and stored in the storage unit 54 as the reference wall surface (second plane F2). That is, in a case where the reception unit 72 has not received the constraint condition for the reference wall surface, the polyhedron creation unit 76 sets the plane candidate extracted by the extraction unit 73 as the reference wall surface.

In a case where the polyhedron creation unit 76 determines in Step S414 that the constraint condition has been set, the flow proceeds to Step S415. In Step S415, the plane determination unit 77 performs the geometric constraint process to be described later. In Step S416, the polyhedron creation unit 76 stores a plane, created by recalculating a plane candidate by the plane determination unit 77 through the geometric constraint process, in the storage unit 54 as the reference wall surface.

In Steps S421 to S428, three side wall surfaces other than the reference wall surface adjacent to the reference bottom surface are formed. In Step S421, the reception unit 72 receives designation of one side wall surface (Side surface 1). Specifically, as illustrated in FIG. 12, a user input of a designated point P3 is received on a desired surface intersecting the first plane F1 on the three-dimensional image of the workpiece W displayed on the display screen 51a of the display unit 51. As a result, the user input for extracting a third plane F3 is received.

In Step S422, similarly to Step S412, the extraction unit 73 extracts a plane candidate of the side wall surface (third plane F3) from the mesh data based on the designated point P3 received in Step S421. Then, the extraction unit 73 stores the extracted plane candidate in the storage unit 54.

In Step S423, the reception unit 72 receives a constraint condition of the third plane F3. As described above, the reception unit 72 can receive a position and an attitude such as positions and intersection angles with respect to the first plane F1 and the second plane F2 as the constraint condition for the third plane F3.

In Step S424, the polyhedron creation unit 76 determines whether the constraint condition for the third plane F3 is set. When the polyhedron creation unit 76 determines that the constraint condition is not set, the flow proceeds to Step S427.

In Step S427, the polyhedron creation unit 76 stores the plane candidate extracted by the extraction unit 73 and stored in the storage unit 54 as the third plane F3. That is, in a case where the reception unit 72 has not received the constraint condition for the third plane F3, the polyhedron creation unit 76 sets the plane candidate extracted by the extraction unit 73 as the third plane F3 (Side surface 1).

In a case where the polyhedron creation unit 76 determines in Step S424 that the constraint condition has been set, the flow proceeds to Step S425. In Step S425, the polyhedron creation unit 76 performs the geometric constraint process to be described later. In Step S426, the polyhedron creation unit 76 stores a plane, created by recalculating a plane candidate by the plane determination unit 77 through the geometric constraint process, in the storage unit 54 as the third plane F3.

In Step S428, it is determined whether the three side wall surfaces (the third plane F3, a fourth plane F4, and a fifth plane F5) have been formed. In a case where not all of the three side wall surfaces have been formed, Steps S421 to S427 are repeated. When the fourth plane F4 and the fifth plane F5 are formed similarly to the third plane F3, the flow proceeds to Step S431.

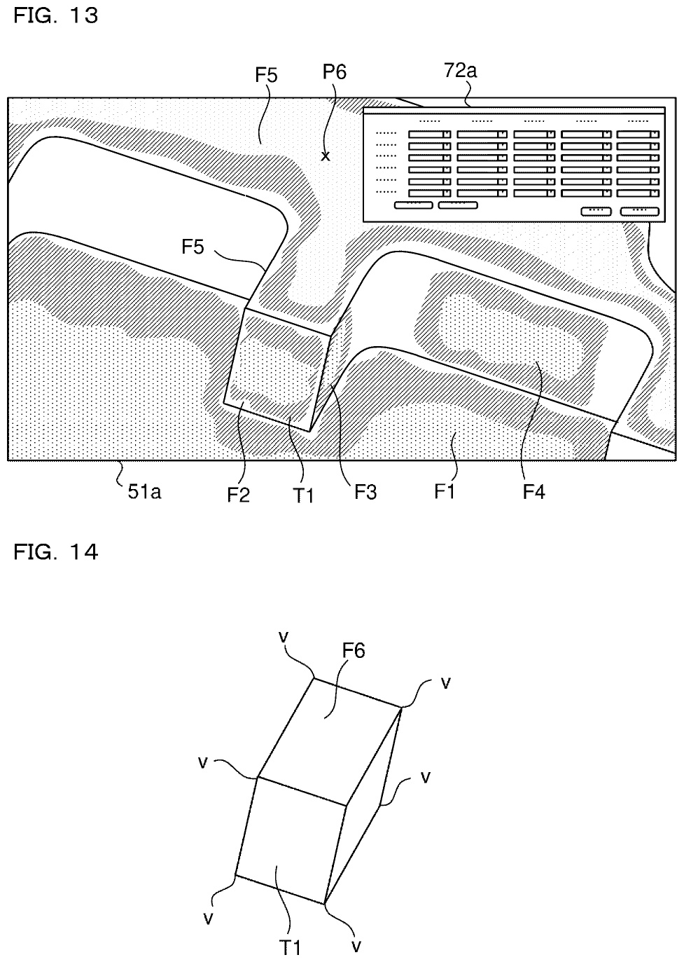

In Step S431, the reception unit 72 receives designation of a top surface facing the reference bottom surface. Specifically, as illustrated in FIG. 13, a user input of a designated point P6 is received on a desired surface facing the first plane F1 on the three-dimensional image of the workpiece W displayed on the display screen 51a of the display unit 51. As a result, the user input for extracting the top surface (a sixth plane F6) is received.

In Step S432, similarly to Step S402, the extraction unit 73 extracts a plane candidate of the top surface from the mesh data based on the designated point P6 received in Step S431. Then, the extraction unit 73 stores the extracted plane candidate in the storage unit 54.

In Step S433, the reception unit 72 receives a constraint condition of the sixth plane F6. As described above, the reception unit 72 can receive designation of a position and an attitude such as a position or an intersection angle with respect to the first plane F1, which is the reference bottom surface, as the constraint condition for the top surface.

In Step S434, the polyhedron creation unit 76 determines whether the constraint condition for the top surface (sixth plane F6) is set. When the polyhedron creation unit 76 determines that the constraint condition is not set, the flow proceeds to Step S437.

In Step S437, the polyhedron creation unit 76 stores the plane candidate extracted by the extraction unit 73 and stored in the storage unit 54 as the top surface (sixth plane F6). That is, in a case where the reception unit 72 has not received the constraint condition for the top surface, the polyhedron creation unit 76 sets the plane candidate extracted by the extraction unit 73 as the top surface.

In a case where the polyhedron creation unit 76 determines in Step S434 that the constraint condition has been set, the flow proceeds to Step S435. In Step S435, the plane determination unit 77 performs the geometric constraint process to be described later. In Step S436, the polyhedron creation unit 76 stores a plane, created by recalculating a plane candidate by the plane determination unit 77 through the geometric constraint process, in the storage unit 54 as the top surface.

Note that the input of the designated point with respect the sixth plane F6 may be omitted, and the sixth plane F6 may be created by a position of an upper edge of any one of the second plane F2, the third plane F3, the fourth plane F4, and the fifth plane F5.

In Step S441, the determination unit 80 determines whether creation of a hexahedron is possible using the first plane F1 to the sixth plane F6. For example, the determination unit 80 can determine that the creation of a hexahedron is impossible in a case where four intersection lines of the second plane F2, the third plane F3, the fourth plane F4, and the fifth plane F5 with the first plane F1 cannot form a quadrangle. Further, the determination unit 80 may determine that the creation of a hexahedron is impossible in a case where any one of the second plane F2 to the fifth plane F5 is parallel to the first plane F1.

In Step S441, in a case where the determination unit 80 determines that the creation of a hexahedron is impossible, the flow proceeds to Step S443. In Step S443, the display control unit 83 displays an error on the display unit 51 as a notification, and returns to the flowchart of FIG. 4. That is, the display unit 51 constitutes a notification unit that issues a notification by display in the case where it is determined that the creation of a hexahedron is impossible.

In Step S441, in a case where the determination unit 80 determines that the creation of a hexahedron is possible, the flow proceeds to Step S442. In Step S442, the first plane F1 to the sixth plane F6 are connected by the polyhedron creation unit 76 to create the hexahedron as illustrated in FIG. 14. Specifically, the polyhedron creation unit 76 calculates intersection points using three adjacent planes among the first plane F1 to the sixth plane F6 constituting the hexahedron. Then, the polyhedron creation unit 76 repeats this intersection point calculation process eight times to calculate eight intersection point coordinates, and sets the calculated eight intersection point coordinates as eight vertex coordinates of the hexahedron.

In Step S444, the polyhedron creation unit 76 stores shape data of the hexahedron in the storage unit 54, and returns to the flowchart of FIG. 4.

Although FIGS. 10 to 14 illustrate the example in which the polyhedron following the rib-shaped element T1 of the workpiece W has been created, a polyhedron following a portion having a recessed shape on the workpiece W can also be created in a similar manner.

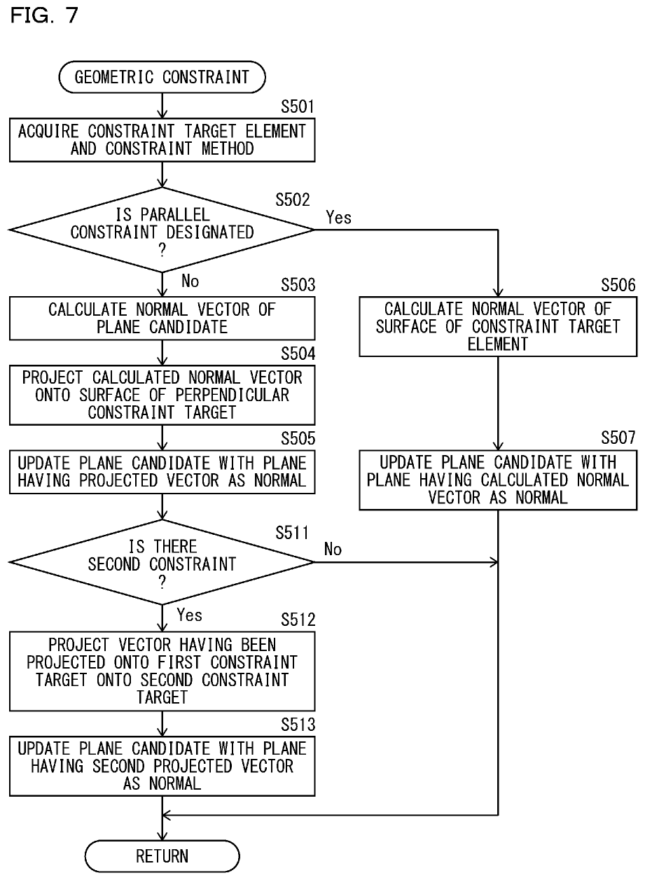

FIG. 7 is a flowchart illustrating an operation of the geometric constraint process. In Step S501 of the geometric constraint process, a constraint condition stored in the storage unit 54 is acquired. Table 1 shows an example of a management table of constraint condition data input to the input screen 72a in Steps S403, S413, S423, and S433 and stored in the storage unit 54. The plane determination unit 77 acquires a constraint target element and a constraint method from the management table of Table 1.

TABLE 1

| | Constraint target | Constraint | Constraint target | Constraint |
|---|---|---|---|---|
| | element 1 | method 1 | element 2 | method 2 |
| Reference | XY-plane | Parallel | | |
| bottom surface | | constraint | | |
| Reference wall | Reference bottom | Perpendicular | | |
| surface | surface | constraint | | |
| Side surface 1 | Reference bottom | Perpendicular | Reference wall | Perpendicular |
| | surface | constraint | surface | constraint |
| Side surface 2 | Reference wall | Parallel | | |
| | surface | constraint | | |
| Side surface 3 | Reference bottom | Perpendicular | Reference wall | Perpendicular |
| | surface | constraint | surface | constraint |
| Top surface | Reference bottom | Parallel | | |
| | surface | constraint | | |

In Step S502, the plane determination unit 77 determines whether the parallel constraint is designated as the constraint condition. In a case where the plane determination unit 77 determines that the parallel constraint is not designated, the flow proceeds to Step S503. In a case where the plane determination unit 77 determines that the parallel constraint is designated, the flow proceeds to Step S506.

In Step S506, the plane determination unit 77 calculates a normal vector of a surface that is a constraint target element of the parallel constraint. For example, a normal vector of the first plane F1, which is a constraint target element with respect to the sixth plane F6, is calculated. In Step S507, a plane having the normal vector calculated in Step S506 as a normal is recalculated by the plane determination unit 77, updated as a plane candidate, and stored in the storage unit 54.

That is, the plane determination unit 77 updates the plane candidate such that an orientation of the normal of the surface, which is the constraint target element of the parallel constraint, coincides with an orientation of a normal of the plane candidate, and determines a plane constituting a polyhedron. As a result, the plane candidate is updated by the plane satisfying the constraint condition at a position defined by a designated point.

Note that the plane determination unit 77 may update the plane candidate with a plane acquired by another method. For example, the plane determination unit 77 may update the plane candidate with a plane that includes, within its surface, a center of gravity of a plane candidate stored in the storage unit 54 before the update and satisfies the constraint condition.

When the plane candidate stored in the storage unit 54 is updated with the plane created by the plane determination unit 77, the flow returns to the flowcharts of FIGS. 5 and 6.

In Step S502, in a case where the plane determination unit 77 determines that the parallel constraint is not designated, the flow proceeds to Step S503. In Step S503, a normal vector of the plane candidate stored in the storage unit 54 is calculated in any step of Steps S402, S412, S422, and S432.

In Step S504, the plane determination unit 77 projects the normal vector calculated in Step S503 onto a plane that is a constraint target element of the perpendicular constraint. For example, a normal vector of a plane candidate of the second plane F2 is projected onto the first plane F1 that is a constraint target element with respect to the second plane F2. In Step S505, a plane having the vector projected in Step S504 as a normal is recalculated by the plane determination unit 77, updated as a plane candidate, and stored in the storage unit 54.

That is, the plane determination unit 77 updates the plane candidate such that an orientation of the normal of the surface, which is the constraint target element of the perpendicular constraint, orthogonal to an orientation of a normal of the plane candidate, and determines a plane constituting the polyhedron. As a result, the plane candidate is updated by the plane satisfying the constraint condition at a position defined by a designated point.

Note that the plane determination unit 77 may update the plane candidate with a plane that includes, within its surface, a center of gravity of a plane candidate stored in the storage unit 54 before the update and satisfies the constraint condition.

In Step S511, the plane determination unit 77 determines whether the second constraint condition (perpendicular constraint) is present. When the plane determination unit 77 determines that the second constraint condition is not present, the flow returns to the flowcharts of FIGS. 5 and 6. When the plane determination unit 77 determines that the second constraint condition is present, the flow proceeds to Step S512.

In Step S512, the plane determination unit 77 further projects the vector projected on the surface of the first constraint target element in Step S504 onto a surface of the second constraint target element. That is, the plane determination unit 77 projects the normal vector of the plane recalculated in Step S505 onto the surface of the second constraint target element.

In Step S513, a plane having the vector projected in Step S512 as a normal is recalculated by the plane determination unit 77, updated as a plane candidate, and stored in the storage unit 54. That is, the plane determination unit 77 updates the plane candidate such that an orientation of the normal of the surface, which is the constraint target element, is orthogonal to an orientation of a normal of the plane candidate, and determines a plane constituting the polyhedron.

Note that the plane determination unit 77 may update the plane candidate with a plane that includes, within its surface, a center of gravity of a plane candidate stored in the storage unit 54 before the update and satisfies the constraint condition. Then, after the plane determination unit 77 updates the plane candidate, the flow returns to the flowcharts of FIGS. 5 and 6.

Note that the case where the perpendicular constraint and the parallel constraint are set with respect to a reference plane as the constraint target element has been described here, but a constraint condition of any angle, such as 30 degrees with respect to the reference surface, can also be set. Also in this case, the plane determination unit 77 updates the plane candidate such that an orientation of the normal of the constraint target element and an orientation of a normal of the plane candidate have a designated angle, and determines a plane constituting the polyhedron. As an example, the plane determination unit 77 projects the normal vector of the plane candidate with respect to a plane obtained by inclining the constraint target element by the designated angle. Then, the plane determination unit 77 can determine the plane constituting the polyhedron by recalculating the plane having the projected vector as the normal.

FIGS. 15 and 16 illustrate a perspective view and a side view when a plurality of hexahedrons have been created by the polyhedron creation unit 76. For example, a plurality of polyhedrons can be created as illustrated in FIGS. 15 and 16 by adding a columnar element T2 to the rib-shaped element T1 of the workpiece W illustrated in FIG. 9 and repeating Steps S303 to S307 in FIG. 4 described above. The conversion unit 81 converts a plurality of geometric elements created by the geometric element creation unit 75 into one piece of assembled CAD data. Then, the output unit 82 outputs the one piece of assembled CAD data.

At this time, in the second mode in which a surface of another geometric element can be set as a constraint target element, for example, it is possible to set constraint conditions for a reference bottom surface (first plane F1′) and a reference wall surface (second plane F2′) of a hexahedron of the element T2 using the reference bottom surface (first plane F1) and the reference wall surface (second plane F2) of the hexahedron of the element T1 as constraint target elements.

For example, as illustrated in FIG. 16, in a case where the sixth plane F6 of the element T1 had an angle with respect to the first plane F1 of the element T1, the reference bottom surface F1′ of the element T2 extracted from the mesh data would be substantially coincident with the sixth plane F6 of the element T1 and be non-parallel with the first plane F1 of the element T1. In this case, in the first mode, when a constraint condition has been set with respect to the other surface of the element T2 using the first plane F1′ of the element T2 as a reference, it is difficult to create a surface parallel to the first plane F1 of the element T1, and the element T1 and the element T2 are not aligned on a straight line.

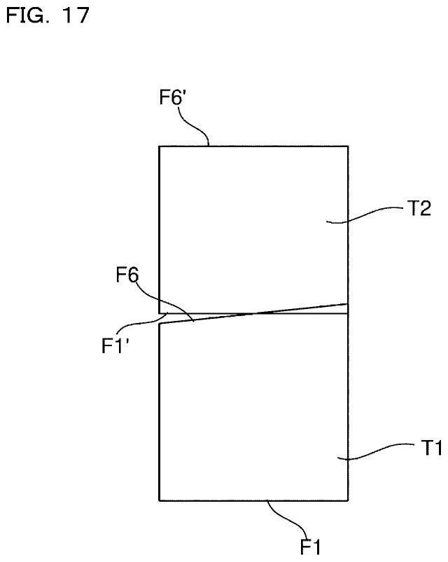

On the other hand, in the second mode, the parallel constraint with respect to the first plane F1 of the element T1 can be set with respect to the first plane F1′ of the element T2 as illustrated in FIG. 17. Further, the parallel constraint of the element T1 with respect to the first plane F1 can be set with respect to a sixth plane F6′ of the element T2. Since the constraint condition based on the surface of the other element T1 can be set with respect to the surface of the element T2 in this manner, it is possible to form a three-dimensional body in which two hexahedrons based on the elements T1 and T2 are adjacently aligned on one plane. Note that the case where the parallel constraint with reference to the surface of the element T1 is set with respect to the surface of the element T2 has been described in the above description, but the perpendicular constraint may be set without being limited to the parallel constraint.

According to the present embodiment, the plane determination unit 77 creates planes constituting a polyhedron based on plane candidates, extracted by receiving user inputs of designated points through the reception unit 72, and designation of constraint conditions received by the reception unit 72. As a result, it is possible to easily create CAD data of the polyhedron following the mesh data at a desired position, and to easily perform CAD modeling.

Further, the extraction unit 73 extracts a group of polygons existing within a predetermined angle range with respect to a normal of a polygon including a designated point among polygons continuous with the polygon including the designated point, and extracts a plane approximate to the extracted group of polygons as a plane candidate. As a result, it is possible to easily extract the plane candidate approximate to a surface on the designated point.

Further, the polyhedron creation unit 76 determines whether a constraint condition has been designated, and uses a plane candidate extracted by the extraction unit 73 as a surface constituting a polyhedron based on a determination result. As a result, the user can select the presence or absence of the constraint condition to create the polyhedron, and a desired hexahedron can be accurately reproduced while securing the flexibility in a shape.

Further, the polyhedron creation unit 76 determines whether a constraint condition has been designated, and uses a plane determined by the plane determination unit 77 based on the constraint condition, as a surface constituting the polyhedron based on a determination result. As a result, the user can select the presence or absence of the constraint condition to create the polyhedron, and a desired hexahedron can be accurately reproduced while securing the flexibility in a shape.

Further, the reception unit 72 receives designation of a position and an attitude with respect to the first plane F1 forming the reference bottom surface of the polyhedron as a constraint condition for the second plane F2 forming the reference wall surface adjacent to the first plane F1, and the plane determination unit 77 creates a plane at the constrained position and attitude with respect to the reference bottom surface as the second plane F2. As a result, the second plane F2 can be easily arranged in a desired attitude.

Further, the reception unit 72 can receive designation of a position and an attitude with respect to an apparatus coordinate system as a constraint condition for the first plane F1. As a result, a polyhedron can be easily created even when a surface having no mesh data, such as the upper surface of the stage of the apparatus, is used as the reference bottom surface.

Further, in a case where a hexahedron is created by the polyhedron creation unit 76, the reception unit 72 can receive designation of positions and attitudes with respect to the first plane F1 and the second plane F2 as constraint conditions for the third plane F3, the fourth plane F4, and the fifth plane F5. Further, designation of a position and an attitude with respect to the first plane F1 can be received as a constraint condition for the sixth plane F6. As a result, the third plane F3 to the sixth plane F6 can be easily arranged in desired attitudes.

Further, the polyhedron creation unit 76 creates the sixth plane F6 based on the position and the attitude with respect to the first plane F1 and the designated point P6. As a result, the sixth plane F6 can be easily created.

Further, the polyhedron creation unit 76 may create the sixth plane using a plane that is parallel to the first plane F1 and intersects the second plane F2, the third plane F3, the fourth plane F4, and the fifth plane F5. As a result, the operation of creating a hexahedron can be simplified.

Further, the polyhedron creation unit 76 calculates an intersection point at which three adjacent planes intersect, and creates a hexahedron having the calculated intersection point as a vertex. As a result, the hexahedron can be easily created.

Further, the determination unit 80 that determines whether or not creation of a polyhedron is possible and the notification unit that issues a notification in a case where the creation of a polyhedron is impossible are provided, the convenience of the reverse engineering support apparatus 7 can be improved.

Further, the polyhedron creation unit 76 can create a plurality of polyhedrons, and can convert the plurality of polyhedrons into one piece of CAD data assembled by the conversion unit 81 and output the one piece of CAD data from the output unit 82. As a result, it is possible to obtain the CAD data of a three-dimensional body in which the plurality of polyhedrons are combined, and it is possible to improve the convenience of the reverse engineering support apparatus 7.

Further, the reception unit 72 has the first mode and the second mode of receiving a position and an attitude with respect to another surface of one polyhedron and a position and an attitude with respect to a surface of another polyhedron, respectively, as a constraint condition for a predetermined surface of the one polyhedron. As a result, it is possible to arrange a plurality of polyhedrons in desired attitudes with respect to desired surfaces.

Further, the conversion unit 81 can convert a polyhedron created by the polyhedron creation unit 76 and a geometric element created based on a user input received by the reception unit 72 into one piece of assembled CAD data, and output the one piece of assembled CAD data from the output unit 82. As a result, it is possible to obtain the CAD data of a three-dimensional body in which the plurality of geometric elements are combined, and it is possible to improve the convenience of the reverse engineering support apparatus 7.

In the present embodiment, mesh data is generated by capturing an image of the workpiece W by the three-dimensional measurement apparatus 1, but an apparatus that acquires mesh data generated by another instrument through the data acquisition unit 84 and performs reverse engineering may be used.

According to the invention, the invention can be used in the reverse engineering support apparatus that supports reverse engineering of creating a CAD drawing from data obtained by measuring a three-dimensional shape.

What is claimed is:

1. A reverse engineering support apparatus that converts a polyhedron, created from mesh data obtained by measuring a three-dimensional shape of a workpiece, into CAD data and outputs the CAD data, the reverse engineering support apparatus comprising:
a data acquisition unit that acquires the mesh data;
a reception unit that receives a designated point on the mesh data and a user input related to a constraint condition for each of surfaces of the polyhedron;
an extraction unit that extracts a plane candidate based on the designated point received by the reception unit from the mesh data;
a plane determination unit that determines a plane constituting the polyhedron based on the plane candidate extracted by the extraction unit and the constraint condition;
a polyhedron creation unit that creates the polyhedron including the plane determined by the plane determination unit; and
a conversion unit that converts the polyhedron created by the polyhedron creation unit into the CAD data.

2. The reverse engineering support apparatus according to claim 1, wherein
the reception unit is capable of receiving, as the user input related to the constraint condition for each of the surfaces of the polyhedron, designation of a position and an attitude with respect to another surface or a position and an attitude in a predetermined coordinate system, and
the plane determination unit determines the plane constituting the polyhedron based on the plane candidate extracted by receiving a user input of the designated point through the reception unit and designation of the constraint condition received by the reception unit.

3. The reverse engineering support apparatus according to claim 1, wherein
the extraction unit extracts a group of polygons existing within a predetermined angle range with respect to a normal of a polygon including a designated point among polygons continuous with the polygon including the designated point, and extracts a plane approximate to the extracted group of polygons as the plane candidate.

4. The reverse engineering support apparatus according to claim 1, wherein
the polyhedron creation unit determines whether the constraint condition has been designated by the reception unit for a plurality of planes constituting the polyhedron, and uses the plane candidate extracted by the extraction unit as a surface constituting the polyhedron based on a result of the determination.

5. The reverse engineering support apparatus according to claim 1, wherein
the polyhedron creation unit determines whether the constraint condition has been designated by the reception unit for a plurality of planes constituting the polyhedron, and uses the plane determined by the plane determination unit based on the constraint condition received by the reception unit as a surface constituting the polyhedron based on the determination result.

6. The reverse engineering support apparatus according to claim 1, wherein
the reception unit receives designation of a position and an attitude with respect to a first plane forming a reference bottom surface of the polyhedron, as the constraint condition for a second plane forming a reference wall surface adjacent to the first plane, and
the plane determination unit creates a plane at the constrained position and attitude with respect to the reference bottom surface as the second plane.

7. The reverse engineering support apparatus according to claim 6, wherein
the reception unit is capable of receiving designation of a position and an attitude with respect to an apparatus coordinate system as the constraint condition for the first plane.

8. The reverse engineering support apparatus according to claim 6, wherein
the plane determination unit determines a third plane, a fourth plane, and a fifth plane that are adjacent to the first plane, which is a reference bottom surface, and form side wall surfaces sequentially continuous with the second plane, which is a reference wall surface, and a sixth plane that forms a top surface facing the first plane,
the polyhedron creation unit creates a hexahedron including the first plane, the second plane, the third plane, the fourth plane, the fifth plane, and the sixth plane created by the plane determination unit, and
the reception unit receives designation of a position and an attitude with respect to at least one of the reference bottom surface or the reference wall surface as the constraint condition for each of the third plane, the fourth plane, the fifth plane, and the sixth plane.

9. The reverse engineering support apparatus according to claim 8, wherein
the plane determination unit creates the sixth plane based on a position and an attitude with respect to the reference bottom surface and the designated point received by the reception unit.

10. The reverse engineering support apparatus according to claim 8, wherein
the plane determination unit creates the sixth plane using a plane that is parallel to the first plane, which is a reference bottom surface, and intersects the second plane, which is a reference wall surfaces, the third plane, the fourth plane, and the fifth plane.

11. The reverse engineering support apparatus according to claim 8, wherein
the polyhedron creation unit calculates an intersection point of three adjacent planes among six planes created by the plane determination unit, and creates a hexahedron having the calculated intersection points as a vertex.

12. The reverse engineering support apparatus according to claim 7, further comprising:
a determination unit that determines whether or not creation of the polyhedron by the polyhedron creation unit is possible; and
a notification unit that issues a notification in a case where the creation of the polyhedron by the determination unit is not possible.

13. The reverse engineering support apparatus according to claim 1, further comprising
an output unit that outputs the CAD data converted by the conversion unit,
wherein the polyhedron creation unit is capable of creating a plurality of the polyhedrons,
the conversion unit converts the plurality of polyhedrons into one piece of assembled CAD data, and
the output unit outputs the one piece of assembled CAD data.

14. The reverse engineering support apparatus according to claim 12, wherein
the reception unit receives selection of one mode out of a first mode in which, as the constraint condition for a predetermined surface of one polyhedron, designation of a position and an attitude with respect to another surface of the one polyhedron is received, and a second mode in which designation of a position and an attitude of a surface of another polyhedron is received as the constraint condition for the predetermined surface of the one polyhedron.

15. The reverse engineering support apparatus according to claim 12, wherein
the reception unit is capable of further receiving a user input for creating a geometric element from the mesh data,
the conversion unit converts the polyhedron created by the polyhedron creation unit and the geometric element created based on the user input received by the reception unit into one piece of assembled CAD data, and
the output unit outputs the one piece of assembled CAD data.
